(19) United States
(12) Patent Application Publication
(10) Pub. No.: US 2026/0200494 A1
(43) Pub. Date: Jul. 16, 2026

(54) METHOD FOR DETECTING ROADWORKS IN A VEHICLE

(71) Applicant: DAIMLER TRUCK AG, Leinfelden-Echterdingen (DE)

(72) Inventors: Philipp MITTMANN, Stuttgart (DE); Margarita KUNJAVSKAJA, Stuttgart (DE); Zhiliang ZHOU, Nürtingen (DE); Sebastian DINGLER, Stuttgart (DE)

(21) Appl. No.: 19/138,812

(22) PCT Filed: Dec. 5, 2023
(86) PCT No.: PCT/EP2023/084374

§ 371 Date: Jun. 13, 2025

(30) Foreign Application Priority Data
Dec. 16, 2022 (DE) 10 2022 133 746.4

(51) Int. Cl. B60W 60/00

(52) U.S. Cl. CPC B60W 60/001; B60W 2420/54

(57) ABSTRACT

Roadworks are detected in a vehicle having at least one an outwardly directed microphone with which acoustic signals from an environment of the vehicle are detected at least in one direction of travel and evaluated in a computing unit to classify at least one device used at roadworks as an object emitting at least some of the acoustic signals with a determinable probability and to detect the roadworks.

### BACKGROUND AND SUMMARY OF THE INVENTION

Exemplary embodiments of the invention relate to a method for detecting roadworks in a vehicle, as well as a vehicle.

In the future, more and more automated vehicles of SAE level 3 to 5 (e.g., lorries, cars, buses, etc.) will be on the roads. The vehicle will take over the fulfilment of the driving task. Just like a human driver, the vehicle needs to understand its surroundings. Automated vehicles use three main sources of information for this:
On-board sensors that perceive the environment live,
A-priori information, which is recorded in advance and stored on an HD map (high-resolution map), and
V2X communication, which represents communication between the vehicle and other vehicles (V2V) or the infrastructure (V2I), for example.

For various reasons, the main focus is on on-board sensor technology and HD cards. With both together, an acceptable level of safety can be achieved. However, a problem arises when the HD card is no longer up-to-date. Roadworks in particular pose a major challenge here. On the one hand, the infrastructure here is often not as well developed as that of normal roads. On the other hand, roadworks are often not static but move, for example when new road surfaces are being laid. Roadworks are sometimes set up overnight and move in terms of their position and/or demarcation. At the same time, driving conditions at roadworks are often worse than in normal traffic infrastructure. By way of example, lanes may be narrower, lane markings less clear and crash barriers and lane markings may not be present. A similar situation arises with short-term adjustments to the traffic flow for road maintenance and road clearance work (e.g., cutting plants and green areas adjacent to the road), as such adjustments are set up and moved within a very short space of time. In such situations, automated vehicles must detect that their map is no longer up-to-date and perform the driving task based solely on the on-board sensors.

EP 2 879 929 B1 describes methods and systems for detecting roadworks using information from multiple sources. In one example, a computing device configured to control the vehicle can be configured to receive information from a plurality of sources relating to the detection of roadworks on the road on which the vehicle is travelling. In addition, the computing device can be configured to determine a probability of existence of the roadworks on the road based on the information. Furthermore, the computing device can be configured to modify a control strategy associated with a driving behavior of the vehicle based on the probability, and to control the vehicle based on the modified control strategy.

Exemplary embodiments of the invention are directed to a novel method for detecting roadworks in a vehicle and a novel vehicle.

A method is disclosed for detecting roadworks in a vehicle which has at least one microphone. According to the invention, the microphone is designed as an outwardly directed microphone with which acoustic signals from an environment of the vehicle are detected at least in one direction of travel and evaluated in a computing unit in order to classify at least one device used at roadworks as an object emitting at least some of the acoustic signals with a determinable probability and to detect the roadworks, for example by means of frequency and/or order analysis.

By way of example, bulldozers, excavators, jackhammers, steamrollers, hedge trimmers, paving machines, etc. can be classified as devices based on the typical characteristics of the acoustic signals.

In one embodiment, the vehicle is operated in an automated driving mode.

In one embodiment, a driving strategy and/or driving behavior of the vehicle is adapted based on the classified object and the probability and a status of the detected roadworks is determined.

In one embodiment, the driving behavior is changed such that the vehicle is operated in a degraded mode, for example at an adapted speed.

In one embodiment, the roadworks are classified based on the classification of the devices and their status is estimated.

In particular, the roadworks can be classified with regard to the features of type, dynamics, and/or activity.

The type of roadworks can be, for example, night roadworks, lane clearance, bridge works, application of a new road surface, lane shifting, etc.

The dynamics of the roadworks can, for example, differentiate between static and dynamic, wherein static roadworks do not move in their boundaries and extent (e.g., bridge work) and dynamic roadworks move (e.g., new road surface, lane clearance).

The activity of the roadworks can, for example, make the distinction between active and inactive, wherein active roadworks are currently being actively operated, such that it must be expected that people are present at the roadworks and changes to the current database can occur at any time, wherein inactive roadworks are not currently being operated, for example no active device is identified based on the acoustic signal for roadworks that are recorded on a digital map available in the vehicle or available wirelessly.

In addition, the classification can be made using the time and usual working hours for the type of roadworks.

By way of example, if the device used has been classified as a hedge trimmer, it can be assumed that the roadworks are active and travelling at a certain speed in a direction of travel of the vehicle.

In one embodiment, the vehicle forwards the detected information to a central database, where it is made available to subsequent vehicles.

In one embodiment, further sensors, for example at least one camera, at least one radar, and/or at least one lidar, can be used to classify the roadworks.

In one embodiment, the additional sensors can be used to record an environment and update a map stored in the central database.

According to one aspect of the present invention, a vehicle, in particular an automated vehicle, for example a commercial vehicle, bus, or passenger car, is disclosed having at least one microphone and configured to perform the method described above.

The present invention enables the early detection of roadworks, as well as the detection of the active or inactive roadwork status by microphones. With the aid of the information, driving behavior can be adapted at an early stage and safety can be increased for all parties involved, in particular for the vehicle, other road users and roadworks personnel.

Exemplary embodiments of the invention are explained in more detail below using drawings.

### BRIEF DESCRIPTION OF THE DRAWING FIGURES

Here are shown:

FIG. 1 a schematic view of a method for detecting roadworks in a vehicle, and

FIG. 2 a schematic view of the vehicle.

### DETAILED DESCRIPTION

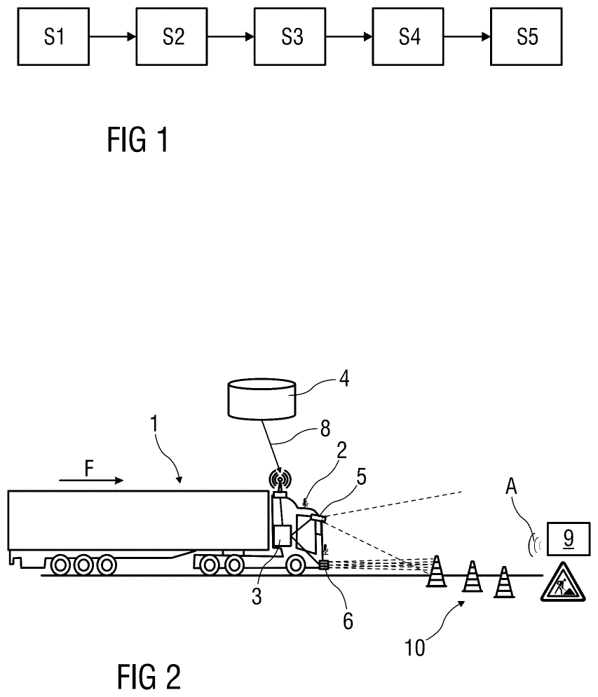

FIG. 1 is a schematic view of a method for detecting roadworks 10 in an automated vehicle 1. FIG. 2 is a schematic view of the vehicle 1. The automated vehicle 1 (for example, a passenger car, bus, or lorry) is in an automated driving mode (for example SAE level 4 or 5) on a roadway, for example a public road, in driving operation and has, among other things, at least one outward-facing microphone 2.

In a step S1, the automated vehicle 1 perceives an acoustic signal A characteristic of roadworks 10 with the at least one microphone 2. In a step S2, the vehicle 1 analyzes the acoustic signal A in a computing unit 3. Machines and devices 9 used at roadworks 10 generate very specific acoustic signals A, which can be analyzed by means of frequency or order analysis and enable an emitting object to be classified with a determinable probability. This allows, for example, bulldozers, excavators, jackhammers, steamrollers, hedge trimmers, paving machines, etc. to be detected. The more acoustic signals A are perceived, the higher the confidence in the evaluation.

In a step S3, the vehicle 1 decides, based on the results of the evaluation and the probability, whether to adapt the driving strategy and driving behavior (e.g., speed) and determines the status of the detected roadworks 10.

On the one hand, based on the early detection using the acoustic signals A, it is possible to detect that there are roadworks 10 on the route without visual perception. This allows the driving behavior of the vehicle 1 to be adapted at an early stage and the vehicle 1 to be operated in a degraded mode (e.g., at an adapted speed). If the roadworks 10 are already present on a map that is accessible, for example, via a wireless connection 8 to a central database 4, this is of course already known.

The roadworks 10 can be classified and their status estimated based on the classification of the devices 9 used. By way of example, if the deployed device 9 has been classified as a hedge trimmer, then it can be assumed that the roadworks 10 are travelling at a certain speed in a direction of travel F of the vehicle 1.

In an optional step S4, the vehicle 1 forwards the detected information to a central database 4. If the detected information, in particular regarding moving roadworks 10, is stored centrally, the information is available for subsequent vehicles that their map will, with a certain probability, no longer be up to date in this area.

In addition to microphones 2, further sensors, for example at least one camera 5, at least one radar, at least one lidar 6 etc. can be used to classify the roadworks 10.

Relevant classifications for roadworks 10 are above all (others are conceivable):
Type: night roadworks, lane clearance, bridge works, laying new road surface, lane shifting;
Static: roadworks 10 do not move within their boundaries and extent (e.g., bridge works),
Dynamic: roadworks 10 are moving (e.g., laying new road surface, lane clearance),
Active: roadworks 10 are currently being actively operated. This means that there could be people at the roadworks 10 and changes to the current database could occur at any time.
Inactive: roadworks 10 are currently not in operation.

Roadworks 10 can also be assigned a permissible combination of classes, such as active dynamic. In this case, it can be assumed that the map is no longer up-to-date when a subsequent vehicle passes through.

In addition, the classification can be carried out using the time and usual working hours for the type of roadworks 10.

If the automated vehicle 1 is equipped with the sensors required to record map data, it can record the environment and update the map in a step S5.

The at least one microphone 2 can also be used, for example, to detect emergency vehicles. In this way, safety can be increased without increased costs.

In the case of unknown roadworks 10, which are considered to be impassable for the vehicle 1, for example a commercial vehicle, based on the evaluated signals, the vehicle 1 can be brought into a safe state before the roadworks 10 and will therefore not lead to a blockage within the roadworks 10 with usually reduced or non-existent stopping possibilities.

Not only is the safety of the automated vehicle 1 currently travelling through increased, but also that of the following traffic.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

Reference numeral list

| | |
|---|---|
| 1 | vehicle |
| 2 | microphone |
| 3 | computing unit |
| 4 | central database |
| 5 | camera |
| 6 | lidar |
| 8 | wireless connection |
| 9 | device |
| 10 | roadworks |
| A | acoustic signal |
| F | direction of travel |
| S1 to S5 | step |

1-10. (canceled)

11. A method for detecting roadworks in a vehicle having at least one microphone, the method comprising:
detecting, by the at least one microphone, acoustic signals from an environment of the vehicle at least in one direction of travel;
evaluating, by a computing unit, the detected acoustic signals to classify at least one device used at roadworks as an object emitting at least some of the acoustic signals with a determinable probability; and
detecting the roadworks based on the classification of the at least one device used at roadworks,
at least one wherein the microphone is outwardly directed from the vehicle.

12. The method of claim 11, wherein the vehicle is operated in an automated driving mode.

13. The method of claim 11, further comprising:
adapting a driving strategy or driving behavior of the vehicle based on the classified at least one and the determinable probability; and
determining a status of the detected roadworks.

14. The method of claim 13, wherein the driving behavior is changed such that the vehicle is operated in a degraded mode.

15. The method of claim 11, wherein the roadworks are classified based on the classification of the at least one device and a status of the at least one device is estimated.

16. The method of claim 11, further comprising:
forwarding, by the vehicle, the detected roadworks to a central database, wherein the central database makes the detected roadworks available to subsequent vehicles.

17. The method of claim 16, wherein the classification of the roadworks further involves using further sensors, wherein the further sensors are at least one camera, at least one radar, or at least one lidar.

18. The method of claim 17, wherein an environment is recorded by the further sensors and a map stored in the central database is updated.

19. The method of claim 15, wherein the roadworks are classified regarding features type, dynamics, or activity.

20. A vehicle comprising:
at least one microphone, which is outwardly directed from the vehicle; and
a computing unit coupled to the at least one microphone,
wherein the at least one microphone is configured to detect acoustic signals from an environment of the vehicle at least in one direction of travel,
wherein the computing unit is configured to
evaluate the detected acoustic signals to classify at least one device used at roadworks as an object emitting at least some of the acoustic signals with a determinable probability; and
detect roadworks based on the classification of the at least one device used at roadworks.
